(19) United States
(12) Patent Application Publication
(10) Pub. No.: US 2011/0301966 A1
(43) Pub. Date: Dec. 8, 2011

(54) REAL-TIME SYNCHRONOUS SEMANTIC PROCESSING IN ELECTRONIC DOCUMENTATION

(75) Inventors: Uri Kartoun, Washington, DC (US); John Christopher Gillotte, Metamora, MI (US); Prabhdeep Singh, Germantown, MD (US); Michael Todd Gillam, Washington, DC (US); Craig F. Feied, Kirkland, WA (US); Jonathan Alan Handler, Northbrook, IL (US)

(73) Assignee: MICROSOFT CORPORATION, Redmond, WA (US)

(21) Appl. No.: 12/795,604

(22) Filed: Jun. 7, 2010

(51) Int. Cl. G06F 17/27; G06Q 50/00; G06F 3/048; G06Q 10/00; G06F 17/24; G06F 15/16

(52) U.S. Cl. 705/2; 715/256; 715/277; 709/203; 715/781; 704/9

(57) ABSTRACT

The synchronous semantic processing technique described herein provides the level of completeness of a document in real-time as a user is creating or editing the document and provides recommendations to the user to increase the level of completeness. In one embodiment, the level of completeness of a medical document, and the state of the components of the document that are used to determine level, are used to make recommendations to a user (e.g., a physician) to provide additional information for the components that determine the level, thereby increasing the level. The level of medical documentation can be represented by an Evaluation and Management (E&M) coding level, which is a U.S. standard defined to evaluate how comprehensive a medical document is. The E&M level is used to determine the completeness of the medical document and to make recommendations to the user to improve the quality and the completeness of the document.

### BACKGROUND

Natural Language Processing (NLP), is a computational approach to analyze oral or written textual information and is based on a set of theories and technologies (e.g., knowledge-engineering, machine-learning, statistics). NLP systems (e.g., information retrieval systems, machine translation systems, dialogue systems), which employ NLP, convert samples of human language into more precise and complete representation.

One application that employs NLP is a NLP server or engine that analyzes a document and provides a level of completeness of a document. In one embodiment, the NLP server/engine provides the level of completeness of a medical document using an Evaluation and Management (E&M) level. The E&M level is a standard for evaluating medical records for filing health insurance claims. The more complete a medical record or document is the higher its E&M level will be. Increased E&M levels can translate directly into increased medical billings.

### SUMMARY

This Summary is provided to introduce a selection of concepts in a simplified form that are further described in the Detailed Description Section. This Summary Section is not intended to identify key features or essential features of the claimed subject matter, nor is it intended to be used to limit the scope of the claimed subject matter.

One embodiment of the synchronous semantic processing technique described herein provides the level of completeness of a document in real-time as a user is creating or editing the document. In one embodiment, the level of completeness of a document, and the state of the components of the document that are used to determine the level, are used to make recommendations to an author to provide additional information for the components that determine the level, thereby increasing the level. For example, in the case of a medical document, the level or score of medical documentation is represented by the term “E&M Code” or “E&M Level”. E&M coding is a U.S. standard defined to evaluate how comprehensive a medical document is. In one embodiment of the technique, the E&M level is used to determine the completeness of the medical document.

In one embodiment of the synchronous semantic processing technique, the technique employs Natural Language Processing (NLP) to determine the level of completeness of a document based on the statuses of extracted components. For example, a patient's medical record is entered by a user at a client computer and submitted to a NLP engine or server which evaluates the medical record and provides the current E&M level, as well as the status of the components of the document that make up the E&M level, back to the client. The technique then uses the current E&M level (and the statuses of the components that make up the level) to provide suggestions to the user who is editing the document on how to increase the level of the document completeness score, i.e., E&M level. The user then continues editing the document based on the recommendations for the current E&M level and the edited document is sent to the NLP server/engine which then again provides a new current level of completeness. The client again computes recommendations to the user who, if desires, further edits the document, repeating this process until a desired level of completeness is reached.

### DESCRIPTION OF THE DRAWINGS

The specific features, aspects, and advantages of the disclosure will become better understood with regard to the following description, appended claims, and accompanying drawings where:

FIG. 1 is an exemplary architecture for employing one exemplary embodiment of the synchronous semantic processing technique described herein.

FIG. 2 depicts a flow diagram of an exemplary process for employing one embodiment of the synchronous semantic processing technique.

FIG. 3 depicts a user interface employed by one exemplary embodiment of the synchronous semantic processing technique.

FIG. 4 is a schematic illustration of an exemplary computing device which can be used to practice the synchronous semantic processing technique.

### DETAILED DESCRIPTION

In the following description of the synchronous semantic processing technique, reference is made to the accompanying drawings, which form a part thereof, and which show by way of illustration examples by which the synchronous semantic processing technique described herein may be practiced. It is to be understood that other embodiments may be utilized and structural changes may be made without departing from the scope of the claimed subject matter.

### 1.0 The Synchronous Semantic Processing Technique

The following sections provide a background of the E&M standard for evaluating medical documents, an overview of the synchronous semantic processing technique, as well as an exemplary architecture and a process for employing the technique. A layout for a user interface for one exemplary embodiment of the technique is also provided. Lastly, a more detailed description of the components and the features of the technique, as well as alternate embodiments, are provided.

### 1.1 Background of the Medical Record Evaluation and Management (E&M) System

One embodiment of the synchronous semantic processing technique provides recommendations for increasing the level of completeness of a medical document based on the Evaluation and Management (E&M) coding system. As such, some background information into the E&M system is useful and is provided in the paragraphs below.

The E&M system provides standard guidelines for creating medical records and other related documents such as medical bills. In general, the E&M system states that each medical record should be complete and legible, and the documentation of each patient encounter should include the reason for the encounter and relevant history, physical examination findings and prior diagnostic test results, diagnosis, a care plan, date and a legible identity of the observer. Additionally, the E&M standard specifies that a medical record should provide the rationale for ordering diagnostic and other related services. The E&M system states that past and present diagnoses should be accessible to the treating and/or consulting physician and that appropriate health risk factors should be identified. The E&M system also states that the patient's progress, response to and changes in treatment, and revision of diagnosis should be documented. And lastly, the E&M system states that codes reported on a health insurance claim form or billing statement should be supported by the documentation in the medical record.

There are three key components of E&M services for visits which consist predominately of counseling or coordination of care. These three key components—history, examination, and medical decision making—appear in the descriptors of documentation for office, hospital and other medical services. Because the level of E&M service is dependent on two or three key components, performance and documentation of one component (e.g., examination) at the highest level does not necessarily mean that the encounter in its entirety qualifies for the highest level of E&M service.

The following paragraphs provide some insight into determining the level of completeness of a medical record or document using the E&M system based on the documentation of history, examination, and medical decision levels. In general, the more complete a medical record is in terms of the documentation of history, examination, and medical decision-making levels, the higher the E&M score/level of the medical document will be.

### 1.1.1 Documentation of History Level

The history level of E&M services is based on four types of history: 1) Problem Focused, 2) Expanded Problem Focused, 3) Detailed, and 4) Comprehensive. Each type of history includes some or all of the following elements: Chief Complaint (CC), History of Present Illness (HPI), Review of Systems (ROS); and 4) Past, Family and/or Social History (PFSH). The extent of history of present illness, review of systems and past, family and/or social history that is obtained and documented is dependent upon clinical judgment and the nature of the presenting problem(s). Table 1 shows the progression of the elements required for each type of history. To qualify for a given type of history all three elements in Table 1 must be met. A chief complaint is assumed at all levels.

TABLE 1
Documentation of History Level

| History of | Review of | Past Family, | |
|---|---|---|---|
| Present | Systems | and/or social | |
| Illness (HPI) | (ROS) | history (PFSH) | Type of History |
| Brief | N/A | N/A | Problem Focused |
| Brief | Problem | N/A | Expanded Problem |
| | Pertinent | | Focused |
| Extended | Extended | Pertinent | Detailed |
| Extended | Completed | Complete | Comprehensive |

The Chief Complaint (CC) is a concise statement describing the symptom, problem, diagnosis, or other factors that are the reason for the patient encounter. The History of Present Illness (HPI) is a chronological description of the development of the patient's illness from the first sign to the present. It includes the following elements: location, quality, severity, duration, timing, context, modifying factors, and associated signs and symptoms. Brief and Extended HPIs are distinguished by the amount of detail needed to accurately characterize the clinical problem(s). A Brief HPI consists of one to three elements of the HPI. An Extended HPI consists of at least four elements of the HPI or the status of at least three chronic or inactive conditions. A Review of Systems (ROS) is an inventory of body systems obtained through a series of questions seeking to identify signs and/or symptoms which the patient may be experiencing or has experienced. For purposes of ROS, the following systems are recognized: constitutional symptoms (e.g., fever, weight loss); eyes; ears, nose, mouth, throat; cardiovascular; respiratory; gastrointestinal; genitourinary; musculoskeletal; integumentary (skin and/or breast); neurological; psychiatric; endocrine; hematologic/lymphatic; and allergic/immunologic. A Problem Pertinent ROS inquires about the system directly related to the problem(s) identified in the HPI. An Extended ROS inquires about the system directly related to the problem(s) identified in the HPI and a limited number of additional systems. A Complete ROS inquires about the system(s) directly related to the problem(s) identified in the HPI in addition to all additional body systems. Past Family and/or Social History (PFSH) consists of a review of a patient's past history; family history; and social history (an age appropriate review of past and current activities). A Pertinent PFSH is a review of the history area(s) directly related to the problem(s) identified in the HPI. A Complete PFSH is of a review of two or all three of the PFSH history areas, depending on the category of the E&M service. A review of all three history areas is required for services that by their nature include a comprehensive assessment or reassessment of the patient. A review of two of the three history areas is sufficient for other services.

### 1.1.2 Documentation of Examination

The levels of E&M services for examination are based on four types of examination: 1) Problem Focused—a limited examination of the affected body area or organ system; 2) Expanded Problem Focused—a limited examination of the affected body area or organ system and any other symptomatic or related body areas or organ systems; 3) Detailed—an extended examination of the affected body areas or organ systems and any other symptomatic or related body areas or organ system; and 4) Comprehensive—a general multi-system examination, or complete examination of a single organ system and other symptomatic or related body areas or organ systems. These types of examinations have been defined for general multi-system and the following single organ systems: cardiovascular; ears, nose, mouth and throat; eyes; genitourinary (female); genitourinary (male); hematologic/lymphatic/immunologic; musculoskeletal; neurological; psychiatric; respiratory; and skin. The type (general multi-system or single organ system) and content of examination are selected by the examining physician and are based upon clinical judgment, the patient's history, and the nature of the presenting problem(s).

The detailed content and documentation requirements for each type and level of examination vary and are beyond the scope of this document. In general, to qualify for a given level of multi-system examination, the following content and documentation requirements should be met: 1) Problem Focused Examination—should include performance and documentation of one to five elements identified in one or more organ system(s) or body area(s); 2) Expanded Problem Focused Examination—should include performance and documentation of at least six elements identified in one or more organ system(s) or body area(s); 3) Detailed Examination—should include at least six organ systems or body areas. For each system/area selected, performance and documentation of at least two elements identified is expected. Alternatively, a detailed examination may include performance and documentation of at least twelve elements identified in two or more organ systems or body areas; and 4) Comprehensive Examination—should include at least nine organ systems or body areas.

To qualify for a given level of single organ system examination, the following content and documentation requirements should be met: 1) Problem Focused Examination—should include performance and documentation of one to five elements identified; 2) Expanded Problem Focused Examination—should include performance and documentation of at least six elements identified; 3) Detailed Examination—examinations other than the eye and psychiatric examinations should include performance and documentation of at least twelve elements identified. Eye and psychiatric examinations should include the performance and documentation of at least nine elements identified; and 4) Comprehensive Examination—should include performance of all elements identified.

### 1.1.3 Documentation of the Complexity of Medical Decision Making

The levels of E&M services recognize four types of medical decision making complexity: 1) Straightforward, 2) Low, 3) Moderate, and 4) High. Medical decision making refers to the complexity of establishing a diagnosis and/or selecting a management option as measured by: 1) the number of possible diagnoses and/or the number of management options that must be considered, 2) the amount and/or complexity of medical records, diagnostic tests, and/or other information that must be obtained, reviewed and analyzed, and 3) the risk of significant complications, morbidity and/or mortality, as well as comorbidities, associated with the patient's presenting problem(s), the diagnostic procedure(s) and/or the possible management options.

Table 2 shows the progression of the elements required for each level of medical decision making. To qualify for a given type of decision making, two of the three elements in the table must be either met or exceeded.

TABLE 2
Progression of Elements for Each
Level of Medical Decision Making

| Number of | Amount and/or | Risk of | |
|---|---|---|---|
| diagnoses or | complexity of | complications | |
| management | data to | and/or morbidity | Type of Decision |
| options | be reviewed | or mortality | Making |
| Minimal | Minimal or None | Minimal | Straightforward |
| Limited | Limited | Low | Low Complexity |
| Multiple | Moderate | Moderate | Moderate |
| | | | Complexity |
| Extensive | Extensive | High | High Complexity |

The number of possible diagnoses and/or the number of management options that must be considered is based on the number and types of problems addressed during the encounter, the complexity of establishing a diagnosis and the management decisions that are made by the physician. The amount and complexity of data to be reviewed is based on the types of diagnostic testing ordered or reviewed. The risk of significant complications, morbidity, and/or mortality is based on the risks associated with the presenting problem(s), the diagnostic procedure(s), and the possible management options. The assessment of risk of the presenting problem(s) is based on the risk related to the disease process anticipated between the present encounter and the next one. The highest level of risk in any one category (presenting problem(s), diagnostic procedure(s), or management options) determines the overall risk.

### 1.2 Overview of the Technique

In one embodiment of the synchronous semantic processing technique, during the clinical electronic documentation process, as the user (e.g., a physician) creates a medical record, the user's input is sent in real-time to a local or remote NLP server or engine. The NLP server/engine provides the E&M level of the document, as well as the status of the E&M components that make up the E&M level (e.g., the status of the components that make up the history level, the examination level and the decision-making level, as discussed previously in Section 1.1). The received E&M level is displayed to the user in real-time as he or she is editing the medical record. Additional information, computed at the user's computing device, includes recommendations for increasing the E&M level of the document. The technique computes recommendations for increasing the level of completeness of the document based on the status of the E&M components that make up the E&M level received from the NLP server/engine. These recommendations include suggestions to provide additional information for the E&M components that make up the medical record.

### 1.3 Exemplary Architecture

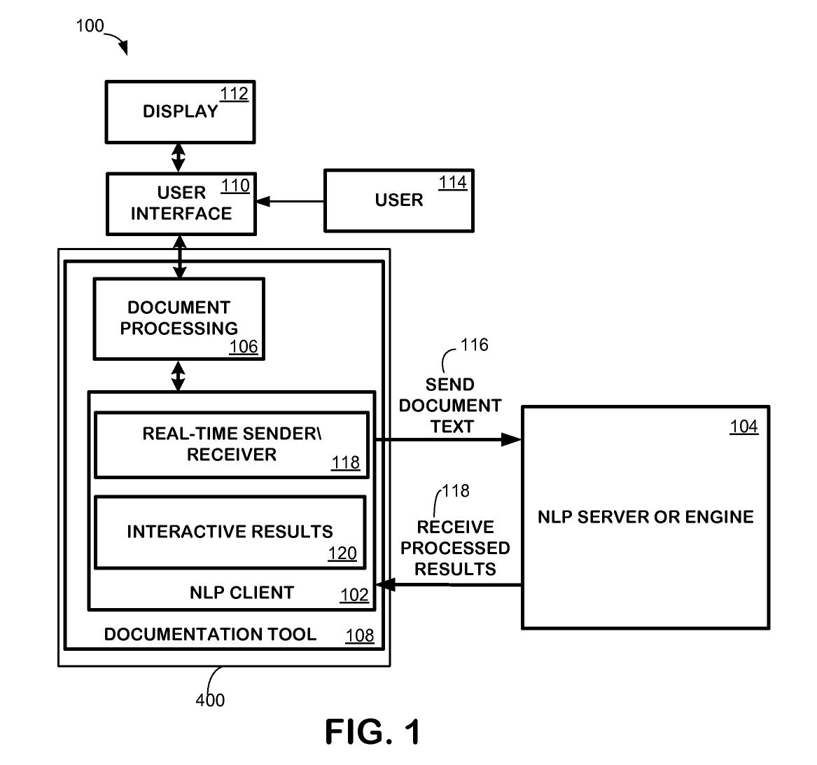

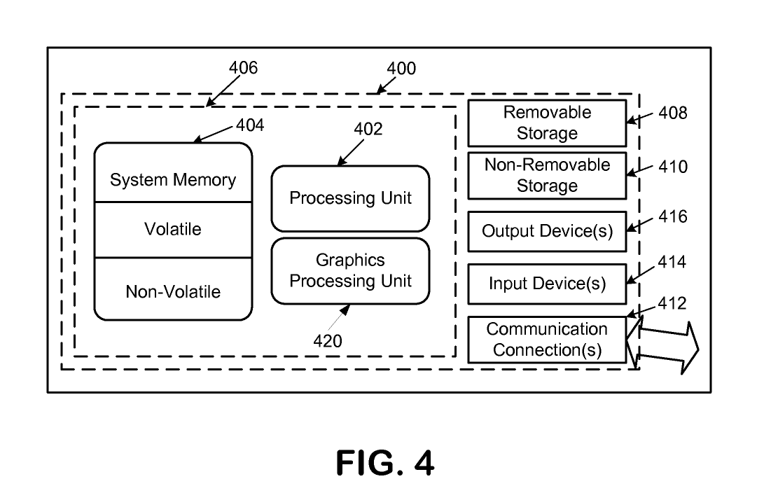

FIG. 1 provides an exemplary architecture 100 for employing one embodiment of the synchronous semantic processing technique. As shown in FIG. 1, the architecture 100 employs a NLP client 102 and a Natural Language Processing (NLP) server or engine 104. Both the NLP client 102 and the NLP server/engine 104 can be implemented using a general purpose computing device 400, such as will be discussed in greater detail with respect to FIG. 4. The NLP client 102 performs document processing 106 using a user interface 110 of a documentation tool 108 such as, for example, a word processor, interactively creating a document or modifying a document displayed on a display 112 of the NLP client. While the document is being modified by a user 114, the text of the document 116 is sent to the NLP server/engine 104 by a real-time sender/receiver 118. The NLP server/engine 104 processes the document text 116 and sends the processed results 118 back to the NLP client 102 in real-time.

In response to receiving the processed results 118, including the level of completeness of the document, the NLP client 102 in real-time computes and provides on the display 112 interactive results 120 that include recommendations on how to improve the level of completeness of the document. The user 114 can act on these suggestions to increase the level of completeness until the desired level of documentation is reached. Each time the user 114 edits the document, the entire text of the document is sent to the NLP server/engine to obtain the current level of completeness (e.g., in one embodiment this is the E&M level).

### 1.4 Exemplary Process for Employing the Synchronous Semantic Processing Technique

The following paragraphs provide descriptions of an exemplary process for employing the synchronous semantic processing technique. It should be understood that in some cases the order of actions can be interchanged, and in some cases some of the actions may even be omitted.

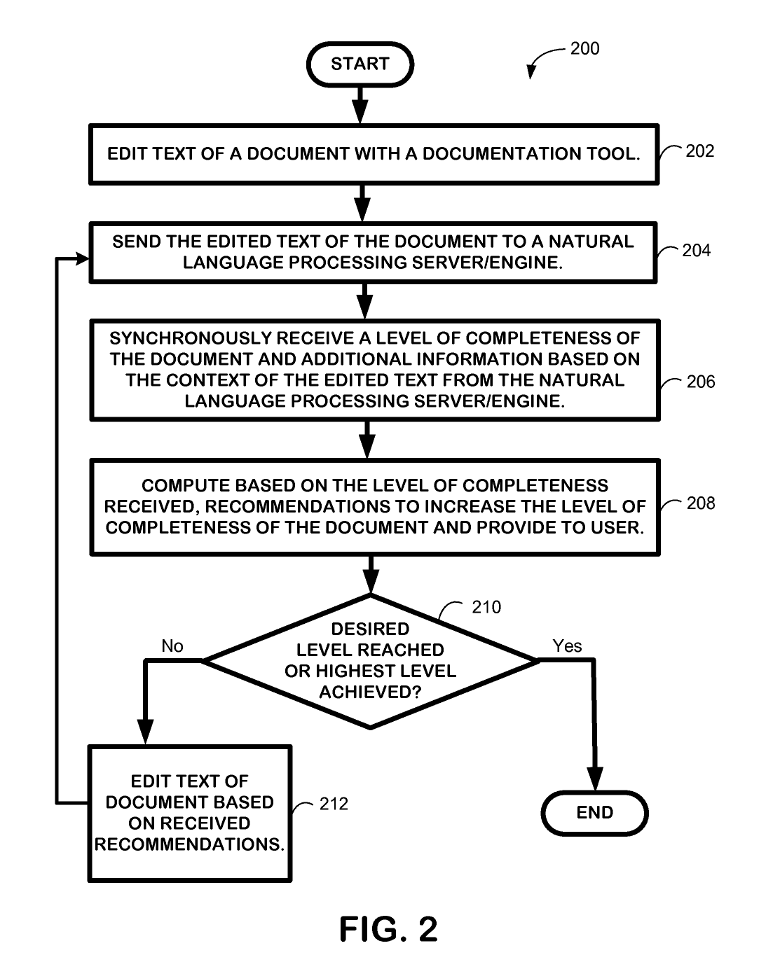

FIG. 2 provides one exemplary process for employing the synchronous semantic processing technique. As shown in block 202, the text of a document is edited with a documentation tool, such a word processor. The edited text of the document is sent to a Natural Language Processing (NLP) server or engine, as shown in block 204. A level of completeness of the document and additional information based on the context of the edited text is synchronously received from the NLP server or engine, as shown in block 206. Recommendations to increase the level of completeness of the document are computed based on the level of completeness received and provided to the user, as shown in block 208. These recommendations can also include document components for which additional information can be provided. If the user is satisfied or the highest level is achieved then the process stops, as shown in block 210. Otherwise, the user can then act on the recommendations and further edit the document text, as shown in block 212. The edited text of the document is then again sent to the NLP server or engine, as shown in block 204. A level of completeness of the document and additional information based on the context of the edited text is synchronously received from the NLP server, as shown in block 206. Recommendations to increase the level of completeness of the document are computed based on both the level of completeness received and additional information, as shown in block 208. These recommendations can also include document components for which additional information can be provided. The user can then decide whether to continue editing the document until the desired level is reached or to stop the process, as shown in blocks 210 and 212.

### 1.5 Exemplary User Interface

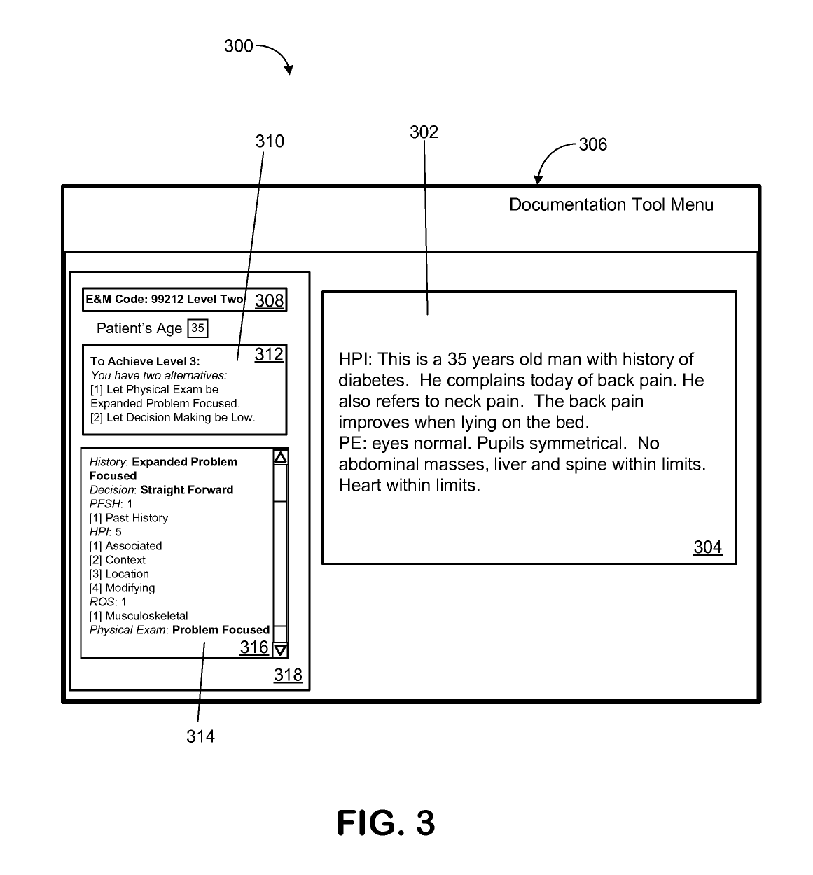

FIG. 3 depicts an exemplary user interface of one embodiment 300 of the synchronous semantic processing technique. Text of a document 302 is displayed in a first window 304 on a display 306 of a computing device. Simultaneously a computed current level of completeness of the document 308 and the recommendations 310 for increasing the completeness of the document in a second window 312 of the display 306. The statuses of the components 314 of the document that make up the level of (e.g., for which additional information can be provided by the user) are shown in a third window 316. In one embodiment of the technique, the level of completeness 308 is the E&M level of the document. Additionally, the components 314 and their statuses are based on the E&M key components that are used to determine the E&M level, as previously discussed in Section 1.1.

### 1.6 Details and Features of Various Exemplary Embodiments of the Synchronous Semantic Processing Technique

Background on the E&M system, an overview of the technique, an exemplary architecture and an exemplary process, as well as an exemplary user interface, having been provided. The following paragraphs provide details of various components of the synchronous semantic processing technique.

### 1.6.1 NLP Server or Engine

Natural Language Processing (NLP) is a computational approach to analyze oral or written textual information and is based on a set of theories and technologies (e.g., knowledge-engineering, machine-learning, statistics). NLP systems (e.g., information retrieval systems, machine translation systems, dialogue systems), which employ NLP, convert samples of human language into more precise and complete representation. In one embodiment of the technique, a NLP server or engine uses NLP to extract terms from a received medical document to determine the status of the E&M components and the E&M level from the input text. (For example, a NLP server can perform the NLP processing or the NLP processing can take place in a NLP engine which can be on a server or on the client's computing device). The status of the E&M components and the E&M level of the document are then provided to the NLP client that sent the medical document. In one embodiment of the technique, all possible levels (as reported by the NLP server/engine in XML in one embodiment) are as specified in Table 3.

TABLE 3
Possible Textual Values for the NLP Engine's Key Components

| | | Medical Decision |
|---|---|---|
| History Level | Level of Exam | Making |
| none | none | none |
| minimal | problemfocused | straightforward |
| problemfocused | expandedproblemfocused | low |
| expandedproblemfocused | detailed | moderate |
| detailed | comprehensive | high |
| comprehensive | | |

The status of the elements that make up these key components, history, examination and medical decision making levels, is also provided to the NLP client in one embodiment. Providing the level of completeness of a medical document using a NLP server or engine is known by those with ordinary skill in the art, however, using the component statuses by a client to provide a recommendation to a user to provide additional information to increase document completeness in real-time as the user edits the document is novel.

### 1.6.2 NLP Client

Referring back to the exemplary user interface 300 shown in FIG. 3, when the user edits (modifies) the document text 302 in a documentation tool 306 (such as a word processor), the NLP client sends the document text 302 to the NLP server or engine over a network and immediately (synchronously) receives a result from the NLP server/engine (in one embodiment this result is provided in XML format).

For example, as shown in FIG. 3, the user inputs document text 302 in the right window 304 as:
“HPI: this is a 35 years old man with history of diabetes. He complains today of back pain. He also refers to neck pain. The back pain improves when lying on the bed.
PE: eyes normal. Pupils symmetrical. No abdominal masses, liver and spleen within limits.
Heart within limits.”
   This yields the display shown in FIG. 3 at the interface 318 of the NLP client. The level of completeness of the document text 302 is shown in window 308. This level is received from the NLP server or engine. The recommendations 310 to increase the level of completeness of the document, are computed by the NLP client, and are shown in window 312. Various components of the document for which additional information can be provided 314 to increase the E&M level are shown in window 316.

In one embodiment, the NLP client sends the input text to the NLP server or engine over a network. The NLP server or engine then sends back the result (E&M level and statuses of the components) to the NLP client (in one embodiment the level and status is provided in XML format). The result file consists of information such as the E&M level (also is denoted as “cpt code”): —<cpt code=“99212”>. Other information included in the result file is the medical elements and medical-related values, i.e., the components that make up the E&M level.

As the user edits the input record, upon each editing operation the most updated record is sent from the NLP client to the NLP server/engine. Any document text that arrives at the engine, generates a new result file which is sent then back to the NLP client. In this real-time procedure the client constantly parses the result file (in one embodiment provided in XML) and generates the interface 318 shown on the left of FIG. 3. Using this information allows for the presentation of a variety of values, for example, using the medical record mentioned above, the following information is presented: History: Expanded Problem Focused; HPI: 5; Physical Exam: Problem Focused.

### 1.6.3 Logic to Provide Recommendations

As discussed above, to provide the recommendations to the user to increase the level of completeness, in one embodiment the technique uses the overall E&M Score/Code. A summary of the possible E&M codes that correspond to the possible documentation levels is shown in Table 4 (established patients are considered). Note that History Level is denoted as HL, Level of Exam\Exam Level denoted as HL and Medical Decision Making\Decision Level is denoted as DL.

TABLE 4
E&M Codes and Corresponding History Level, Examination
Level and Medical Decision-Making Level

| | | History Level | Level of Exam | Medical Decision |
|---|---|---|---|---|
| | | (HL) | (EL) | Making (DL) |
| E&M | 99212 | Problem Focused | Problem Focused | Straight Forward |
| Code | 99213 | Expanded | Expanded | Low |
| | | Problem | Problem | |
| | | Focused | Focused | |
| | 99214 | Detailed | Detailed | Moderate |
| | 99215 | Comprehensive | Comprehensive | High |

The NLP client translates the above textual values into numerical values. Then depending on the current E&M level of the document being edited, there is a corresponding table that calculates the information that allows a user to increase the E&M level (Tables 6, 8, 10, and 12). The possible textual values (along with their corresponding assigned numerical values) as reported by the NLP server/engine as part of its XML are shown in Table 5.

TABLE 5
Possible Textual Values Along with Corresponding Assigned Numerical Values

| History Level (HL) | | Level of Exam (EL) | | Medical Decision Making (DL) | |
|---|---|---|---|---|---|
| none | 0 | none | 0 | none | 0 |
| minimal | 1 | problemfocused | 1 | straightforward | 1 |
| problemfocused | 2 | expandedproblemfocused | 2 | low | 2 |
| expandedproblemfocused | 3 | detailed | 3 | moderate | 3 |
| detailed | 4 | comprehensive | 4 | high | 4 |
| comprehensive | 5 | | | | |

If at least two out of three categories are addressed by a certain level, as determined by Tables 6, 8, 10 and 12 provided in the following sections, then it means that the document is documented at that level. For example, if HL is “Expanded Problem Focused” (represented by the value “3”) and DL is “Low” (represented by the value “2”) then it means that the E&M code is 99213, i.e., Level 3 (regardless EL since two out of the three conditions needed to get Level 3 are already fulfilled).

### 1.6.3.1 Logic for Increasing Level from Two to Three

An exemplary computation for recommending how a user can edit a medical record to go from an E&M level of two to three employs Table 6. The boldfaced values indicate the minimum value for two of the three, history, exam or decision levels, needed to advance to the next level.

TABLE 6
History, Exam and Medical Decision-Making Levels
Needed to Achieve a Level 3 from a Level 2

| | | | | | | |
|---|---|---|---|---|---|---|
| History Level (HL) | 0 | 1 | 2 | 3 | 4 | 5 |
| Level of Exam (EL) | 0 | 1 | 2 | 3 | 4 | — |
| Medical Decision Making (DL) | 0 | 1 | 2 | 3 | 4 | — |

Referring to Table 6, for a document to reach a level 3, at least two out of three are needed: HL to be “Expanded Problem Focused” (represented by the value “3”), EL be “Expanded Problem Focused” (represented by the value “2”), and DL be “Low” (represented by the value “2”). From this information the technique can generate a set of rules and present output guidance to the user, as presented in Table 7. Table 7 provides the recommendations provided to a user to go from a level two to a level three. For example, assume that currently the document is at Level 2, HL=0, EL=2, and DL=1. This means that EL is accomplished for this level (see Table 6). To go one level up it is necessary to accomplish HL or accomplish DL (to achieve two of the three levels of HL, EL and DL). For Level 3, to accomplish HL, HL needs to be equal at least to 3 (Expanded Problem Focused) and to accomplish DL, DL needs to be equal at least to 2 (Low). Hence, as shown in Table 7, the technique displays to the user the guidance text: “You have two options: (i) Let HL be Expanded Problem Focused or (ii) Let DL be Low.” Additionally, in one embodiment, the technique also displays to the user the E&M components that make up the HL, EL, and DL levels to indicate where additional information might be provided to increase the respective levels.

As another example, assume that currently the document is at Level 2, HL=1, EL=1, and DL=1. This means that none of the categories have been accomplished. To go one level up it is necessary to accomplish at least two out of three: HL & EL, HL & DL, or EL & DL. The user then is guided to follow one of three documentation alternatives to be in “Level 3”, corresponding to the HL=1, EL=1 and DL=1 columns (see Table 7). Note that a different set of rules is defined to progress from one level to the next.

TABLE 7
Recommendations based on HL, EL and DL Levels to Increase
the Level of Documentation from Level 2 to Level 3

| HL | EL | DL | Recommendation |
|---|---|---|---|
| 0 | 0 | 0 | You have three options: (i) Let HL be Expanded Problem Focused and EL be |
| | | | Expanded Problem Focused, or (ii) Let HL be Expanded Problem Focused and |
| | | | DL be Expanded Problem Focus, or (iii) Let Exam be Expanded Problem |
| | | | Focused and DL be Low. |
| 0 | 0 | 1 | You have three options: (i) Let HL be Expanded Problem Focused and EL be |
| | | | Expanded Problem Focused, or (ii) Let HL be Expanded Problem Focused and |
| | | | DL be Expanded Problem Focus, or (iii) Let Exam be Expanded Problem |
| | | | Focused and DL be Low. |
| 0 | 0 | 2 | You have two options: (i) Let HL be Expanded Problem Focused or (ii) Let DL be |
| | | | Low. |
| 0 | 1 | 0 | You have three options: (i) Let HL be Expanded Problem Focused and EL be |
| | | | Expanded Problem Focused, or (ii) Let HL be Expanded Problem Focused and |
| | | | DL be Expanded Problem Focus, or (iii) Let Exam be Expanded Problem |
| | | | Focused and DL be Low. |
| 0 | 1 | 1 | You have three options: (i) Let HL be Expanded Problem Focused and EL be |
| | | | Expanded Problem Focused, or (ii) Let HL be Expanded Problem Focused and |
| | | | DL be Expanded Problem Focus, or (iii) Let Exam be Expanded Problem |
| | | | Focused and DL be Low. |
| 0 | 1 | 2 | You have two options: (i) Let HL be Expanded Problem Focused or (ii) Let EL be |
| | | | Expanded Problem Focused. |
| 0 | 2 | 0 | You have two options: (i) Let HL be Expanded Problem Focused or (ii) Let DL be |
| | | | Low. |
| 0 | 2 | 1 | You have two options: (i) Let HL be Expanded Problem Focused or (ii) Let |
| | | | DL be Low. |
| 1 | 0 | 0 | You have three options: (i) Let HL be Expanded Problem Focused and EL be |
| | | | Expanded Problem Focused, or (ii) Let HL be Expanded Problem Focused and |
| | | | DL be Expanded Problem Focus, or (iii) Let Exam be Expanded Problem |
| | | | Focused and DL be Low. |
| 1 | 0 | 1 | You have three options: (i) Let HL be Expanded Problem Focused and EL be |
| | | | Expanded Problem Focused, or (ii) Let HL be Expanded Problem Focused and |
| | | | DL be Expanded Problem Focus, or (iii) Let Exam be Expanded Problem |
| | | | Focused and DL be Low. |
| 1 | 0 | 2 | You have two options: (i) Let HL be Expanded Problem Focused or (ii) Let EL be |
| | | | Expanded Problem Focused. |
| 1 | 1 | 0 | You have three options: (i) Let HL be Expanded Problem Focused and EL be |
| | | | Expanded Problem Focused, or (ii) Let HL be Expanded Problem Focused and |
| | | | DL be Expanded Problem Focus, or (iii) Let Exam be Expanded Problem |
| | | | Focused and DL be Low. |
| 1 | 1 | 1 | You have three options: (i) Let HL be Expanded Problem Focused and EL |
| | | | be Expanded Problem Focused, or (ii) Let HL be Expanded Problem |
| | | | Focused and DL be Expanded Problem Focus, or (iii) Let Exam be |
| | | | Expanded Problem Focused and DL be Low. |
| 1 | 1 | 2 | You have two options: (i) Let HL be Expanded Problem Focused or (ii) Let EL be |
| | | | Expanded Problem Focused. |
| 1 | 2 | 0 | You have two options: (i) Let HL be Expanded Problem Focused or (ii) Let DL be |
| | | | Low. |
| 1 | 2 | 1 | You have two options: (i) Let HL be Expanded Problem Focused or (ii) Let DL be |
| | | | Low. |
| 2 | 0 | 0 | You have three options: (i) Let HL be Expanded Problem Focused and EL be |
| | | | Expanded Problem Focused, or (ii) Let HL be Expanded Problem Focused and |
| | | | DL be Expanded Problem Focus, or (iii) Let Exam be Expanded Problem |
| | | | Focused and DL be Low. |
| 2 | 0 | 1 | You have three options: (i) Let HL be Expanded Problem Focused and EL be |
| | | | Expanded Problem Focused, or (ii) Let HL be Expanded Problem Focused and |
| | | | DL be Expanded Problem Focus, or (iii) Let Exam be Expanded Problem |
| | | | Focused and DL be Low. |
| 2 | 0 | 2 | You have two options: (i) Let HL be Expanded Problem Focused or (ii) Let EL be |
| | | | Expanded Problem Focused. |
| 2 | 1 | 0 | You have three options: (i) Let HL be Expanded Problem Focused and EL be |
| | | | Expanded Problem Focused, or (ii) Let HL be Expanded Problem Focused and |
| | | | DL be Expanded Problem Focus, or (iii) Let Exam be Expanded Problem |
| | | | Focused and DL be Low. |
| 2 | 1 | 1 | You have three options: (i) Let HL be Expanded Problem Focused and EL be |
| | | | Expanded Problem Focused, or (ii) Let HL be Expanded Problem Focused and |
| | | | DL be Expanded Problem Focus, or (iii) Let Exam be Expanded Problem |
| | | | Focused and DL be Low. |
| 2 | 1 | 2 | You have two options: (i) Let HL be Expanded Problem Focused or (ii) Let EL be |
| | | | Expanded Problem Focused. |
| 2 | 2 | 0 | You have two options: (i) Let HL be Expanded Problem Focused or (ii) Let DL be |
| | | | Low. |
| 2 | 2 | 1 | You have two options: (i) Let HL be Expanded Problem Focused or (ii) Let DL be |
| | | | Low. |
| 3 | 0 | 0 | You have two options: (i) Let EL be Expanded Problem Focused or (ii) Let DL be |
| | | | Low. |
| 3 | 0 | 1 | You have two options: (i) Let EL be Expanded Problem Focused or (ii) Let DL be |
| | | | Low. |
| 3 | 1 | 0 | You have two options: (i) Let EL be Expanded Problem Focused or (ii) Let DL be |
| | | | Low. |
| 3 | 1 | 1 | You have two options: (i) Let EL be Expanded Problem Focused or (ii) Let DL be |
| | | | Low. |

### 1.6.3.2 Logic for Increasing Documentation Level from One to Two

Table 8 provides the history level, examination level and medical-decision making level needed to increase the level of documentation of a medical document from Level 1 to Level 2. The boldfaced numbers in Table 8 in the HL, EL and DL rows represent the numerical values needed to achieve Level 2. Table 9 provides the corresponding recommendations given to the user based on the current HL, EL and DL levels of the document.

TABLE 8
History, Exam and Decision Levels Needed
to Achieve a Level 2 from a Level 1

| | | | | | | |
|---|---|---|---|---|---|---|
| History Level (HL) | 0 | 1 | 2 | 3 | 4 | 5 |
| Level of Exam (EL) | 0 | 1 | 2 | 3 | 4 | — |
| Medical Decision Making (DL) | 0 | 1 | 2 | 3 | 4 | — |

TABLE 9
Recommendations based on HL, EL and DL Levels to Increase
the Level of Documentation from Level 1 to Level 2

| HL | EL | DL | Recommendation |
|---|---|---|---|
| 0 | 0 | 0 | You have three options: (i) Let HL be Problem Focused and EL be Problem |
| | | | Focused, or (ii) Let HL be Problem Focused and DL be Straight Forward, or (iii) |
| | | | Let Exam be Problem Focused and DL be Straight Forward. |
| 0 | 0 | 1 | You have two options: (i) Let EL be Problem Focused or (ii) Let HL be Problem |
| | | | Focused. |
| 0 | 1 | 0 | You have two options: (i) Let DL be Straight Forward or (ii) Let HL be Problem |
| | | | Focused. |
| 1 | 0 | 0 | You have three options: (i) Let HL be Problem Focused and EL be Problem |
| | | | Focused, or (ii) Let HL be Problem Focused and DL be Straight Forward, or (iii) |
| | | | Let Exam be Problem Focused and DL be Straight Forward. |
| 1 | 0 | 1 | You have two options: (i) Let EL be Problem Focused or (ii) Let HL be Problem |
| | | | Focused. |
| 1 | 1 | 0 | You have two options: (i) Let DL be Straight Forward or (ii) Let HL be Problem |
| | | | Focused. |
| 2 | 0 | 0 | You have two options: (i) Let EL be Problem Focused or (ii) Let DL be Straight |
| | | | Forward. |

### 1.6.3.3 Logic for Increasing Documentation Level from Three to Four

Table 10 provides the history level, examination level and medical-decision making level needed to increase the level of documentation of a medical document from level 3 to level 4. The boldfaced numbers in Table 10 in the HL, EL and DL rows show the minimal numerical value needed to achieve Level 4. Table 11 provides the corresponding recommendations made to a user based on the current HL, EL and DL level of the document.

TABLE 10
History, Exam and Decision Levels Needed
to Achieve a Level 4 from a Level 3

| | | | | | | |
|---|---|---|---|---|---|---|
| History Level (HL) | 0 | 1 | 2 | 3 | 4 | 5 |
| Level of Exam (EL) | 0 | 1 | 2 | 3 | 4 | — |
| Medical Decision Making (DL) | 0 | 1 | 2 | 3 | 4 | — |

TABLE 11
Recommendations based on HL, EL and DL Levels to Increase
the Level of Documentation from Level 3 to Level 4

| HL | EL | DL | Recommendation |
|---|---|---|---|
| 0 | 0 | 0 | You have three options: (i) Let HL be Detailed and EL be Detailed, or (ii) |
| | | | Let HL be Detailed and DL be Moderate, or (iii) Let Exam be Detailed |
| | | | and DL be Moderate. |
| 0 | 1 | 0 | You have three options: (i) Let HL be Detailed and EL be Detailed, or (ii) |
| | | | Let HL be Detailed and DL be Moderate, or (iii) Let Exam be Detailed |
| | | | and DL be Moderate. |
| 0 | 2 | 0 | You have three options: (i) Let HL be Detailed and EL be Detailed, or (ii) |
| | | | Let HL be Detailed and DL be Moderate, or (iii) Let Exam be Detailed |
| | | | and DL be Moderate. |
| 0 | 3 | 0 | You have two options: (i) Let HL be Detailed or (ii) Let DL be Moderate. |
| 0 | 0 | 1 | You have three options: (i) Let HL be Detailed and EL be Detailed, or (ii) |
| | | | Let HL be Detailed and DL be Moderate, or (iii) Let Exam be Detailed |
| | | | and DL be Moderate. |
| 0 | 1 | 1 | You have three options: (i) Let HL be Detailed and EL be Detailed, or (ii) |
| | | | Let HL be Detailed and DL be Moderate, or (iii) Let Exam be Detailed |
| | | | and DL be Moderate. |
| 0 | 2 | 1 | You have three options: (i) Let HL be Detailed and EL be Detailed, or (ii) |
| | | | Let HL be Detailed and DL be Moderate, or (iii) Let Exam be Detailed |
| | | | and DL be Moderate. |
| 0 | 3 | 1 | You have two options: (i) Let HL be Detailed or (ii) Let DL be Moderate. |
| 0 | 0 | 2 | You have three options: (i) Let HL be Detailed and EL be Detailed, or (ii) |
| | | | Let HL be Detailed and DL be Moderate, or (iii) Let Exam be Detailed |
| | | | and DL be Moderate. |
| 0 | 1 | 2 | You have three options: (i) Let HL be Detailed and EL be Detailed, or (ii) |
| | | | Let HL be Detailed and DL be Moderate, or (iii) Let Exam be Detailed |
| | | | and DL be Moderate. |
| 0 | 2 | 2 | You have three options: (i) Let HL be Detailed and EL be Detailed, or (ii) |
| | | | Let HL be Detailed and DL be Moderate, or (iii) Let Exam be Detailed |
| | | | and DL be Moderate. |
| 0 | 3 | 2 | You have two options: (i) Let HL be Detailed or (ii) Let DL be Moderate. |
| 0 | 0 | 3 | You have two options: (i) Let HL be Detailed or (ii) Let EL be Detailed. |
| 0 | 1 | 3 | You have two options: (i) Let HL be Detailed or (ii) Let EL be Detailed. |
| 0 | 2 | 3 | You have two options: (i) Let HL be Detailed or (ii) Let EL be Detailed. |
| 1 | 0 | 0 | You have three options: (i) Let HL be Detailed and EL be Detailed, or (ii) |
| | | | Let HL be Detailed and DL be Moderate, or (iii) Let Exam be Detailed |
| | | | and DL be Moderate. |
| 1 | 1 | 0 | You have three options: (i) Let HL be Detailed and EL be Detailed, or (ii) |
| | | | Let HL be Detailed and DL be Moderate, or (iii) Let Exam be Detailed |
| | | | and DL be Moderate. |
| 1 | 2 | 0 | You have three options: (i) Let HL be Detailed and EL be Detailed, or (ii) |
| | | | Let HL be Detailed and DL be Moderate, or (iii) Let Exam be Detailed |
| | | | and DL be Moderate. |
| 1 | 3 | 0 | you have two options: (i) Let HL be Detailed or (ii) Let DL be Moderate. |
| 1 | 0 | 1 | You have three options: (i) Let HL be Detailed and EL be Detailed, or (ii) |
| | | | Let HL be Detailed and DL be Moderate, or (iii) Let Exam be Detailed |
| | | | and DL be Moderate. |
| 1 | 1 | 1 | You have three options: (i) Let HL be Detailed and EL be Detailed, or (ii) |
| | | | Let HL be Detailed and DL be Moderate, or (iii) Let Exam be Detailed |
| | | | and DL be Moderate. |
| 1 | 2 | 1 | You have three options: (i) Let HL be Detailed and EL be Detailed, or (ii) |
| | | | Let HL be Detailed and DL be Moderate, or (iii) Let Exam be Detailed |
| | | | and DL be Moderate. |
| 1 | 3 | 1 | You have two options: (i) Let HL be Detailed or (ii) Let DL be Moderate. |
| 1 | 0 | 2 | You have three options: (i) Let HL be Detailed and EL be Detailed, or (ii) |
| | | | Let HL be Detailed and DL be Moderate, or (iii) Let Exam be Detailed |
| | | | and DL be Moderate. |
| 1 | 1 | 2 | You have three options: (i) Let HL be Detailed and EL be Detailed, or (ii) |
| | | | Let HL be Detailed and DL be Moderate, or (iii) Let Exam be Detailed |
| | | | and DL be Moderate. |
| 1 | 2 | 2 | You have three options: (i) Let HL be Detailed and EL be Detailed, or (ii) |
| | | | Let HL be Detailed and DL be Moderate, or (iii) Let Exam be Detailed |
| | | | and DL be Moderate. |
| 1 | 3 | 2 | You have two options: (i) Let HL be Detailed or (ii) Let DL be Moderate. |
| 1 | 0 | 3 | You have two options: (i) Let HL be Detailed or (ii) Let EL be Detailed. |
| 1 | 1 | 3 | You have two options: (i) Let HL be Detailed or (ii) Let EL be Detailed. |
| 1 | 2 | 3 | You have two options: (i) Let HL be Detailed or (ii) Let EL be Detailed. |
| 2 | 0 | 0 | You have three options: (i) Let HL be Detailed and EL be Detailed, or (ii) |
| | | | Let HL be Detailed and DL be Moderate, or (iii) Let Exam be Detailed |
| | | | and DL be Moderate. |
| 2 | 1 | 0 | You have three options: (i) Let HL be Detailed and EL be Detailed, or (ii) |
| | | | Let HL be Detailed and DL be Moderate, or (iii) Let Exam be Detailed |
| | | | and DL be Moderate. |
| 2 | 2 | 0 | You have three options: (i) Let HL be Detailed and EL be Detailed, or (ii) |
| | | | Let HL be Detailed and DL be Moderate, or (iii) Let Exam be Detailed |
| | | | and DL be Moderate. |
| 2 | 3 | 0 | You have two options: (i) Let HL be Detailed or (ii) Let DL be Moderate. |
| 2 | 0 | 1 | You have three options: (i) Let HL be Detailed and EL be Detailed, or (ii) |
| | | | Let HL be Detailed and DL be Moderate, or (iii) Let Exam be Detailed |
| | | | and DL be Moderate. |
| 2 | 1 | 1 | You have three options: (i) Let HL be Detailed and EL be Detailed, or (ii) |
| | | | Let HL be Detailed and DL be Moderate, or (iii) Let Exam be Detailed |
| | | | and DL be Moderate. |
| 2 | 2 | 1 | You have three options: (i) Let HL be Detailed and EL be Detailed, or (ii) |
| | | | Let HL be Detailed and DL be Moderate, or (iii) Let Exam be Detailed |
| | | | and DL be Moderate. |
| 2 | 3 | 1 | You have two options: (i) Let HL be Detailed or (ii) Let DL be Moderate. |
| 2 | 0 | 2 | You have three options: (i) Let HL be Detailed and EL be Detailed, or (ii) |
| | | | Let HL be Detailed and DL be Moderate, or (iii) Let Exam be Detailed |
| | | | and DL be Moderate. |
| 2 | 1 | 2 | You have three options: (i) Let HL be Detailed and EL be Detailed, or (ii) |
| | | | Let HL be Detailed and DL be Moderate, or (iii) Let Exam be Detailed |
| | | | and DL be Moderate. |
| 2 | 2 | 2 | You have three options: (i) Let HL be Detailed and EL be Detailed, or (ii) |
| | | | Let HL be Detailed and DL be Moderate, or (iii) Let Exam be Detailed |
| | | | and DL be Moderate. |
| 2 | 3 | 2 | You have two options: (i) Let HL be Detailed or (ii) Let DL be Moderate. |
| 2 | 0 | 3 | You have two options: (i) Let HL be Detailed or (ii) Let EL be Detailed. |
| 2 | 1 | 3 | You have two options: (i) Let HL be Detailed or (ii) Let EL be Detailed. |
| 2 | 2 | 3 | You have two options: (i) Let HL be Detailed or (ii) Let EL be Detailed. |
| 3 | 0 | 0 | You have three options: (i) Let HL be Detailed and EL be Detailed, or (ii) |
| | | | Let HL be Detailed and DL be Moderate, or (iii) Let Exam be Detailed |
| | | | and DL be Moderate. |
| 3 | 1 | 0 | You have three options: (i) Let HL be Detailed and EL be Detailed, or (ii) |
| | | | Let HL be Detailed and DL be Moderate, or (iii) Let Exam be Detailed |
| | | | and DL be Moderate. |
| 3 | 2 | 0 | You have three options: (i) Let HL be Detailed and EL be Detailed, or (ii) |
| | | | Let HL be Detailed and DL be Moderate, or (iii) Let Exam be Detailed |
| | | | and DL be Moderate. |
| 3 | 3 | 0 | You have two options: (i) Let HL be Detailed or (ii) Let DL be Moderate. |
| 3 | 0 | 1 | You have three options: (i) Let HL be Detailed and EL be Detailed, or (ii) |
| | | | Let HL be Detailed and DL be Moderate, or (iii) Let Exam be Detailed |
| | | | and DL be Moderate. |
| 3 | 1 | 1 | You have three options: (i) Let HL be Detailed and EL be Detailed, or (ii) |
| | | | Let HL be Detailed and DL be Moderate, or (iii) Let Exam be Detailed |
| | | | and DL be Moderate. |
| 3 | 2 | 1 | You have three options: (i) Let HL be Detailed and EL be Detailed, or (ii) |
| | | | Let HL be Detailed and DL be Moderate, or (iii) Let Exam be Detailed |
| | | | and DL be Moderate. |
| 3 | 3 | 1 | You have two options: (i) Let HL be Detailed or (ii) Let DL be Moderate. |
| 3 | 0 | 2 | You have three options: (i) Let HL be Detailed and EL be Detailed, or (ii) |
| | | | Let HL be Detailed and DL be Moderate, or (iii) Let Exam be Detailed |
| | | | and DL be Moderate. |
| 3 | 1 | 2 | You have three options: (i) Let HL be Detailed and EL be Detailed, or (ii) |
| | | | Let HL be Detailed and DL be Moderate, or (iii) Let Exam be Detailed |
| | | | and DL be Moderate. |
| 3 | 2 | 2 | You have three options: (i) Let HL be Detailed and EL be Detailed, or (ii) |
| | | | Let HL be Detailed and DL be Moderate, or (iii) Let Exam be Detailed |
| | | | and DL be Moderate. |
| 3 | 3 | 2 | You have two options: (i) Let HL be Detailed or (ii) Let DL be Moderate. |
| 3 | 0 | 3 | You have two options: (i) Let HL be Detailed or (ii) Let EL be Detailed. |
| 3 | 1 | 3 | You have two options: (i) Let HL be Detailed or (ii) Let EL be Detailed. |
| 3 | 2 | 3 | You have two options: (i) Let HL be Detailed or (ii) Let EL be Detailed. |
| 4 | 0 | 0 | You have two options: (i) Let EL be Detailed or (ii) Let DL be Moderate. |
| 4 | 1 | 0 | You have two options: (i) Let EL be Detailed or (ii) Let DL be Moderate. |
| 4 | 2 | 0 | You have two options: (i) Let EL be Detailed or (ii) Let DL be Moderate. |
| 4 | 0 | 1 | You have two options: (i) Let EL be Detailed or (ii) Let DL be Moderate. |
| 4 | 1 | 1 | You have two options: (i) Let EL be Detailed or (ii) Let DL be Moderate. |
| 4 | 2 | 1 | You have two options: (i) Let EL be Detailed or (ii) Let DL be Moderate. |
| 4 | 0 | 2 | You have two options: (i) Let EL be Detailed or (ii) Let DL be Moderate. |
| 4 | 1 | 2 | You have two options: (i) Let EL be Detailed or (ii) Let DL be Moderate. |
| 4 | 2 | 2 | You have two options: (i) Let EL be Detailed or (ii) Let DL be Moderate. |

### 1.6.3.4 Logic for Increasing Documentation Level from Four to Five

Table 12 provides the history level, examination level and medical-decision making level needed to increase the level of documentation of a medical document from level 4 to level 5. The boldfaced numbers in Table 12 in the HL, EL and DL rows show the minimal numerical value needed to achieve Level 5. Table 13 provides the corresponding recommendations provided to a user based on the current HL, EL and DL level of the document.

TABLE 12
History, Exam and Decision Levels Needed
to Achieve Level 5 from Level 4

| | | | | | | |
|---|---|---|---|---|---|---|
| History Level (HL) | 0 | 1 | 2 | 3 | 4 | 5 |
| Level of Exam (EL) | 0 | 1 | 2 | 3 | 4 | — |
| Medical Decision Making (DL) | 0 | 1 | 2 | 3 | 4 | — |

TABLE 13
Recommendations based on HL, EL and DL Levels to Increase
the Level of Documentation from Level 4 to Level 5

| HL | EL | DL | Recommendation |
|---|---|---|---|
| 0 | 0 | 0 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 0 | 1 | 0 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 0 | 2 | 0 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 0 | 3 | 0 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 0 | 4 | 0 | You have two options: (i) Let HL be Comprehensive or (ii) Let DL be |
| | | | High. |
| 0 | 0 | 1 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 0 | 1 | 1 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 0 | 2 | 1 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 0 | 3 | 1 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 0 | 4 | 1 | You have two options: (i) Let HL be Comprehensive or (ii) Let DL be |
| | | | High. |
| 0 | 0 | 2 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 0 | 1 | 2 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 0 | 2 | 2 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 0 | 3 | 2 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 0 | 4 | 2 | You have two options: (i) Let HL be Comprehensive or (ii) Let DL be |
| | | | High. |
| 0 | 0 | 3 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 0 | 1 | 3 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 0 | 2 | 3 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 0 | 3 | 3 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 0 | 4 | 3 | You have two options: (i) Let HL be Comprehensive or (ii) Let DL be |
| | | | High. |
| 0 | 0 | 4 | You have two options: (i) Let HL be Comprehensive or (ii) Let EL be |
| | | | High. |
| 0 | 1 | 4 | You have two options: (i) Let HL be Comprehensive or (ii) Let EL be |
| | | | High. |
| 0 | 2 | 4 | You have two options: (i) Let HL be Comprehensive or (ii) Let EL be |
| | | | High. |
| 0 | 3 | 4 | You have two options: (i) Let HL be Comprehensive or (ii) Let EL be |
| | | | High. |
| 1 | 0 | 0 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 1 | 1 | 0 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 1 | 2 | 0 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 1 | 3 | 0 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 1 | 4 | 0 | You have two options: (i) Let HL be Comprehensive or (ii) Let DL be |
| | | | High. |
| 1 | 0 | 1 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 1 | 1 | 1 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 1 | 2 | 1 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 1 | 3 | 1 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 1 | 4 | 1 | You have two options: (i) Let HL be Comprehensive or (ii) Let DL be |
| | | | High. |
| 1 | 0 | 2 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 1 | 1 | 2 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 1 | 2 | 2 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 1 | 3 | 2 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 1 | 4 | 2 | You have two options: (i) Let HL be Comprehensive or (ii) Let DL be |
| | | | High. |
| 1 | 0 | 3 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 1 | 1 | 3 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 1 | 2 | 3 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 1 | 3 | 3 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 1 | 4 | 3 | You have two options: (i) Let HL be Comprehensive or (ii) Let DL be |
| | | | High. |
| 1 | 0 | 4 | You have two options: (i) Let HL be Comprehensive or (ii) Let EL be |
| | | | High. |
| 1 | 1 | 4 | You have two options: (i) Let HL be Comprehensive or (ii) Let EL be |
| | | | High. |
| 1 | 2 | 4 | You have two options: (i) Let HL be Comprehensive or (ii) Let EL be |
| | | | High. |
| 1 | 3 | 4 | You have two options: (i) Let HL be Comprehensive or (ii) Let EL be |
| | | | High. |
| 2 | 0 | 0 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 2 | 1 | 0 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 2 | 2 | 0 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 2 | 3 | 0 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 2 | 4 | 0 | You have two options: (i) Let HL be Comprehensive or (ii) Let DL be |
| | | | High. |
| 2 | 0 | 1 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 2 | 1 | 1 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 2 | 2 | 1 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 2 | 3 | 1 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 2 | 4 | 1 | You have two options: (i) Let HL be Comprehensive or (ii) Let DL be |
| | | | High. |
| 2 | 0 | 2 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 2 | 1 | 2 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 2 | 2 | 2 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 2 | 3 | 2 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 2 | 4 | 2 | You have two options: (i) Let HL be Comprehensive or (ii) Let DL be |
| | | | High. |
| 2 | 0 | 3 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 2 | 1 | 3 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 2 | 2 | 3 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 2 | 3 | 3 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 2 | 4 | 3 | You have two options: (i) Let HL be Comprehensive or (ii) Let DL be |
| | | | High. |
| 2 | 0 | 4 | You have two options: (i) Let HL be Comprehensive or (ii) Let EL be |
| | | | High. |
| 2 | 1 | 4 | You have two options: (i) Let HL be Comprehensive or (ii) Let EL be |
| | | | High. |
| 2 | 2 | 4 | You have two options: (i) Let HL be Comprehensive or (ii) Let EL be |
| | | | High. |
| 2 | 3 | 4 | You have two options: (i) Let HL be Comprehensive or (ii) Let EL be |
| | | | High. |
| 3 | 0 | 0 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 3 | 1 | 0 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 3 | 2 | 0 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 3 | 3 | 0 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 3 | 4 | 0 | You have two options: (i) Let HL be Comprehensive or (ii) Let DL be |
| | | | High. |
| 3 | 0 | 1 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 3 | 1 | 1 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 3 | 2 | 1 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 3 | 3 | 1 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 3 | 4 | 1 | You have two options: (i) Let HL be Comprehensive or (ii) Let DL be |
| | | | High. |
| 3 | 0 | 2 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 3 | 1 | 2 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 3 | 2 | 2 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 3 | 3 | 2 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 3 | 4 | 2 | You have two options: (i) Let HL be Comprehensive or (ii) Let DL be |
| | | | High. |
| 3 | 0 | 3 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 3 | 1 | 3 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 3 | 2 | 3 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 3 | 3 | 3 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 3 | 4 | 3 | You have two options: (i) Let HL be Comprehensive or (ii) Let DL be |
| | | | High. |
| 3 | 0 | 4 | You have two options: (i) Let HL be Comprehensive or (ii) Let EL be |
| | | | High. |
| 3 | 1 | 4 | You have two options: (i) Let HL be Comprehensive or (ii) Let EL be |
| | | | High. |
| 3 | 2 | 4 | You have two options: (i) Let HL be Comprehensive or (ii) Let EL be |
| | | | High. |
| 3 | 3 | 4 | You have two options: (i) Let HL be Comprehensive or (ii) Let EL be |
| | | | High. |
| 4 | 0 | 0 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 4 | 1 | 0 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 4 | 2 | 0 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 4 | 3 | 0 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 4 | 4 | 0 | You have two options: (i) Let HL be Comprehensive or (ii) Let DL be |
| | | | High. |
| 4 | 0 | 1 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 4 | 1 | 1 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 4 | 2 | 1 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 4 | 3 | 1 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 4 | 4 | 1 | You have two options: (i) Let HL be Comprehensive or (ii) Let DL be |
| | | | High. |
| 4 | 0 | 2 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 4 | 1 | 2 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 4 | 2 | 2 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 4 | 3 | 2 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 4 | 4 | 2 | You have two options: (i) Let HL be Comprehensive or (ii) Let DL be |
| | | | High. |
| 4 | 0 | 3 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 4 | 1 | 3 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 4 | 2 | 3 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 4 | 3 | 3 | You have three options: (i) Let HL be Comprehensive and EL be |
| | | | Comprehensive, or (ii) Let HL be Comprehensive and DL be High, or (iii) |
| | | | Let Exam be Comprehensive and DL be High. |
| 4 | 4 | 3 | You have two options: (i) Let HL be Comprehensive or (ii) Let DL be |
| | | | High. |
| 4 | 0 | 4 | You have two options: (i) Let HL be Comprehensive or (ii) Let EL be |
| | | | High. |
| 4 | 1 | 4 | You have two options: (i) Let HL be Comprehensive or (ii) Let EL be |
| | | | High. |
| 4 | 2 | 4 | You have two options: (i) Let HL be Comprehensive or (ii) Let EL be |
| | | | High. |
| 4 | 3 | 4 | You have two options: (i) Let HL be Comprehensive or (ii) Let EL be |
| | | | High. |
| 5 | 0 | 0 | You have two options: (i) Let EL be Comprehensive or (ii) Let DL be |
| | | | High. |
| 5 | 1 | 0 | You have two options: (i) Let EL be Comprehensive or (ii) Let DL be |
| | | | High. |
| 5 | 2 | 0 | You have two options: (i) Let EL be Comprehensive or (ii) Let DL be |
| | | | High. |
| 5 | 3 | 0 | You have two options: (i) Let EL be Comprehensive or (ii) Let DL be |
| | | | High. |
| 5 | 0 | 1 | You have two options: (i) Let EL be Comprehensive or (ii) Let DL be |
| | | | High. |
| 5 | 1 | 1 | You have two options: (i) Let EL be Comprehensive or (ii) Let DL be |
| | | | High. |
| 5 | 2 | 1 | You have two options: (i) Let EL be Comprehensive or (ii) Let DL be |
| | | | High. |
| 5 | 3 | 1 | You have two options: (i) Let EL be Comprehensive or (ii) Let DL be |
| | | | High. |
| 5 | 0 | 2 | You have two options: (i) Let EL be Comprehensive or (ii) Let DL be |
| | | | High. |
| 5 | 1 | 2 | You have two options: (i) Let EL be Comprehensive or (ii) Let DL be |
| | | | High. |
| 5 | 2 | 2 | You-have two options: (i) Let EL be Comprehensive or (ii) Let DL be |
| | | | High. |
| 5 | 3 | 2 | You have two options: (i) Let EL be Comprehensive or (ii) Let DL be |
| | | | High. |
| 5 | 0 | 3 | You have two options: (i) Let EL be Comprehensive or (ii) Let DL be |
| | | | High. |
| 5 | 1 | 3 | You have two options: (i) Let EL be Comprehensive or (ii) Let DL be |
| | | | High. |
| 5 | 2 | 3 | You have two options: (i) Let EL be Comprehensive or (ii) Let DL be |
| | | | High. |
| 5 | 3 | 3 | You have two options: (i) Let EL be Comprehensive or (ii) Let DL be |
| | | | High. |

### 1.7 Alternate Embodiments

Although the above-description has related to increasing the documentation level or E&M level of a medical document, those with ordinary skill in the art in which the claimed technique is made for, shall realize that alternate embodiments are possible. For example, the level of completeness of any document can be determined by using a different scheme than E&M level as long as components that make up the level can be identified and corresponding rules for creating recommendations for increasing the level can be made. Additionally, a server or engine which is not based on NLP techniques, can possibly be used as long as there is a way to extract the status of components that make up the document level and the associated overall document level: Lastly, although the previous discussions above referred to a NLP server or engine accessed over a network, it should be realized that a NLP application can run locally on the user's computer.

One alternate embodiment of the synchronous semantic processing technique employs a voice-based approach. Instead of using a typical documentation tool (such as word processor) to type a medical document (e.g., block 108 in FIG. 1), this alternate embodiment uses a documentation tool that employs a voice processor (using an audio sensor such as, for example, a microphone) to capture and analyze an oral input of document text and to present the analysis of that input to the user (e.g., E&M level and recommendations to improve the completeness of the oral representation of a medical story) in a form of a voice, using a speaker.

### 2.0 The Computing Environment

The synchronous semantic processing technique is designed to operate in a computing environment. The following description is intended to provide a brief, general description of a suitable computing environment in which the synchronous semantic processing technique can be implemented. The technique is operational with numerous general purpose or special purpose computing system environments or configurations. Examples of well known computing systems, environments, and/or configurations that may be suitable include, but are not limited to, personal computers, server computers, hand-held or laptop devices (for example, media players, notebook computers, cellular phones, personal data assistants, voice recorders), multiprocessor systems, microprocessor-based systems, set-top boxes, programmable consumer electronics, network PCs, minicomputers, mainframe computers, distributed computing environments that include any of the above systems or devices, and the like.

FIG. 4 illustrates an example of a suitable computing system environment. The computing system environment is only one example of a suitable computing environment and is not intended to suggest any limitation as to the scope of use or functionality of the present technique. Neither should the computing environment be interpreted as having any dependency or requirement relating to any one or combination of components illustrated in the exemplary operating environment. With reference to FIG. 4, an exemplary system for implementing the synchronous semantic processing technique includes a computing device, such as computing device 400. In its most basic configuration, computing device 400 typically includes at least one processing unit 402 and memory 404. Depending on the exact configuration and type of computing device, memory 404 may be volatile (such as RAM), non-volatile (such as ROM, flash memory, etc.) or some combination of the two. This most basic configuration is illustrated in FIG. 4 by dashed line 406. Additionally, device 400 may also have additional features/functionality. For example, device 400 may also include additional storage (removable and/or non-removable) including, but not limited to, magnetic or optical disks or tape. Such additional storage is illustrated in FIG. 4 by removable storage 408 and non-removable storage 410. Computer storage media includes volatile and nonvolatile, removable and non-removable media implemented in any method or technology for storage of information such as computer readable instructions, data structures, program modules or other data. Memory 404, removable storage 408 and non-removable storage 410 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 400.

Device 400 also can contain communications connection(s) 412 that allow the device to communicate with other devices and networks. Communications connection(s) 412 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal, thereby changing the configuration or state of the receiving device of the signal. By way of example, and not limitation, communication media includes wired media such as a wired network or direct-wired connection, and wireless media such as acoustic, RF, infrared and other wireless media. The term computer readable media as used herein includes both storage media and communication media.

Device 400 may have various input device(s) 414 such as a display, keyboard, microphone, mouse, pen, camera, touch input device, and so on. Output device(s) 416 devices such as a display, speakers, a printer, and so on may also be included. All of these devices are well known in the art and need not be discussed at length here.

The synchronous semantic processing technique may be described in the general context of computer-executable instructions, such as program modules, being executed by a computing device. Generally, program modules include routines, programs, objects, components, data structures, and so on, that perform particular tasks or implement particular abstract data types. The synchronous semantic processing technique may be practiced in distributed computing environments where tasks are performed by remote processing devices that are linked through a communications network. In a distributed computing environment, program modules may be located in both local and remote computer storage media including memory storage devices.

It should also be noted that any or all of the aforementioned alternate embodiments described herein may be used in any combination desired to form additional hybrid embodiments. Although the subject matter has been described in language specific to structural features and/or methodological acts, it is to be understood that the subject matter defined in the appended claims is not necessarily limited to the specific features or acts described above. The specific features and acts described above are disclosed as example forms of implementing the claims.

What is claimed is:

1. A computer-implemented process for creating documentation, comprising:
using a computing device for:
editing text of a document with a documentation tool,
sending the edited text of the document to a natural language processing engine;
synchronously receiving a level of completeness of the document and additional information based on the context of the edited text from the natural language processing engine; and
computing, based on the level of completeness received, recommendations to increase the level of completeness of the document.

2. The computer-implemented process of claim 1 further comprising displaying the computed recommendations to increase the level of completeness of the document on the display of the computing device.

3. The computer-implemented process of claim 2, further comprising:
editing the document text of the document based on the recommendations received;
sending the edited text of the document to the natural language processing engine;
synchronously receiving a level of completeness of the document and additional information based on the context of the edited text from the natural language processing engine.

4. The computer-implemented process of claim 2, further comprising:
displaying the edited text of the document in a first window on the display; and
synchronously displaying a current level of completeness of the document received from the natural language processing engine and the recommendations in a second window of the display.

5. The computer-implemented process of claim 1 wherein the received level of completeness of the document is received from the natural language processing engine over a network.

6. The computer-implemented process of claim 2 wherein the received level of completeness of the document is displayed in real-time, wherein real-time is substantially as quickly as the text is edited.

7. The computer-implemented process of claim 6 wherein the document is a medical document and wherein the additional information received from the natural language processing engine is a set of medical elements and medical-related values.

8. The computer-implemented process of claim 1 wherein the level of completeness and the additional information is received from the natural language processing engine in a textual data format.

9. The computer-implemented process of claim 1 wherein the document is a medical document and wherein the level of documentation is based on a standard Evaluation and Management level.

10. The computer-implemented process of claim 9 wherein the level of documentation of the medical document can be increased by providing additional information on one or more of:
patient history,
level of examination, and
medical decision making

11. The computer-implemented process of claim 1, wherein the natural language processing engine resides on the computing device where the document text is being edited.

12. The computer-implemented process of claim 1, wherein the documentation tool further comprises a voice processing tool further comprising:
an audio sensor for receiving orally input document text; and
an analyzer for analyzing the orally input document text to create the edited text that is sent to the natural language processing engine; and wherein
the recommendations to increase level of completeness of the document text are provided using a speaker.

13. A synchronous semantic document processing system for improving the completeness of a document, comprising:
a general purpose computing device;
a computer program comprising program modules executable by the general purpose computing device, wherein the computing device is directed by the program modules of the computer program to,
perform document processing of a medical document at a natural language processing client to modify portions of the document's text;
while the medical document is being modified send the modified document text from the natural language processing client to a natural language processing server in real-time;
receive a level of documentation of the modified medical document from the natural language processing server with status information on elements of the document;
use the level of documentation received and the status information on the elements of the document to compute suggestions for increasing the level of documentation of the medical document; and
display both the modified document text and the suggestions for increasing the level of documentation of the medical document simultaneously on a display of the computing device.

14. The system of claim 13, further comprising sending the modified document text, the level of documentation and the status of information of the elements over a network between the natural language processing client and the natural language processing server.

15. The system of claim 13, wherein the level of documentation of the medical document is a standard Evaluation and Management level.

16. The system of claim 13, wherein the entire medical document is sent to the NLP server each time the document is edited.

17. A computer-implemented process for interactively improving an electronic document, comprising:
using a computing device for:
displaying text of a document in a first window on a display of the computing device; and
simultaneously displaying a computed current level of completeness of the document and the recommendations for increasing the completeness of the document in a second window of the display.

18. The computer-implemented process of claim 16, further comprising:
displaying additional text added to the document in the first window; and
simultaneously displaying a computed new level of completeness of the document and additional recommendations for increasing the completeness of the document based on the additional text added in the second window of the display.

19. The computer-implemented process of claim 16, wherein the document is a medical document and the additional added text relates to additional information regarding patient history, examination history and medical decision making related to a patient corresponding to the medical document.

20. The computer-implemented process of claim 18, further comprising displaying additional components for patient history, examination history and medical decision making for which additional information can be provided in a third window of the display.
